(19) United States
(12) Patent Application Publication
(10) Pub. No.: US 2015/0040509 A1
(43) Pub. Date: Feb. 12, 2015

(54) NATURAL FIBER PLASTIC COMPOSITE

(71) Applicants: Piia Peltola, Hämeenlinna (FI); Liisa Lehtinen, Turku (FI); Markku Kuitunen, Lahti (FI)

(72) Inventors: Piia Peltola, Hämeenlinna (FI); Liisa Lehtinen, Turku (FI); Markku Kuitunen, Lahti (FI)

(73) Assignee: UPM-KYMMENE CORPORATION, Helsinki (FI)

(21) Appl. No.: 14/389,146

(22) PCT Filed: Mar. 29, 2012
(86) PCT No.: PCT/FI2012/050317

§ 371 Date: Sep. 29, 2014

(51) Int. Cl. E04C 2/22; E04F 15/02; B32B 5/16; E04F 13/21; B29C 47/06; B32B 27/08

(52) U.S. Cl. CPC E04C 2/22; B29C 47/065; B32B 27/08; B32B 5/16; E04F 13/21; E04F 15/02044; B32B 2250/02; B32B 2250/24; B32B 2262/062; B32B 2305/08; B32B 2419/00; B29L 2009/00
USPC 52/582.1; 428/300.7; 264/173.16

(57) ABSTRACT

The invention relates to a natural fiber plastic composite product comprising a first layer and a second layer, the first layer forming at least a part of the surface of the product. The first layer comprises thermoplastic polymer and cellulose based particles, and the second layer comprises thermoplastic polymer and impurities. The content of the impurities is greater in the second layer of the product than in the first layer of the product. In addition, the invention relates to a method for manufacturing a natural fiber plastic composite product, a use of a natural fiber plastic composite product, and an arrangement comprising a natural fiber plastic composite product.

### FIELD OF THE INVENTION

This invention relates to a natural fiber plastic composite product and a building and a terrace comprising a natural fiber plastic composite product. The invention further relates to a method for manufacturing a natural fiber plastic composite product. In addition, the invention relates to the use of a natural fiber plastic composite product and an arrangement comprising a fastener, a fastening member, a base element, and a natural fiber plastic composite product.

### BACKGROUND OF THE INVENTION

Natural fiber plastic composite products typically comprise wood material, such as saw dust, and at least one kind of plastic polymer. The composite products may be used for several purposes, for example for furniture, deck floors, fences, window frames, and door frames.

### SUMMARY OF THE INVENTION

The present invention discloses a method for manufacturing a natural fiber plastic composite product. The present invention further discloses a natural fiber plastic composite product, a building comprising a natural fiber plastic composite product, a terrace comprising a natural fiber plastic composite product, and the use of the natural fiber plastic composite product in a building or in a terrace. In addition, the present invention comprises an arrangement comprising a natural fiber plastic composite product, a base element and a fastener.

The amount of recycled raw materials and/or other raw materials of uneven quality may need to be increased in natural fiber plastic composite products due to environmental or economic reasons. However, it has been observed that the strength properties and/or the appearance of a manufactured product may become too poor if the product comprises too much said raw materials. Therefore, it may be difficult to use, for example, as much recycled raw materials as desired.

The natural fiber plastic composite product according to the present invention comprises a first layer and a second layer. The first layer comprises thermoplastic polymer and cellulose based particles, and the second layer comprises thermoplastic polymer and impurities. The impurities may come, for example, from recycled raw materials.

The first layer forms at least a part of the surface of the product. In other words, the first layer covers the second layer at least partly. The amount of the impurities is preferably greater in the second layer of the product than in the first layer of the product. Preferably, the impurities consist of lignin(s), print ink(s), silicone(s) and/or adhesive(s).

The total amount of lignin is preferably smaller in the first layer of the product than in the second layer of the product. Alternatively or in addition, the total amount of print ink is smaller in the first layer of the product than in the second layer of the product. Alternatively or in addition, the total amount of silicone is smaller in the first layer of the product than in the second layer of the product. Alternatively or in addition, the total amount of adhesives is smaller in the first layer of the product than in the second layer of the product.

Thanks to the first layer covering at least a part of the second layer, the second layer may comprise lots of recycled material. For example, the second layer may comprise dark colored recycled material even if the manufactured product has a light color.

The method for manufacturing natural fiber plastic composite product comprises:
forming a first layer of the product, the first layer comprising thermoplastic polymer material and cellulose based particles, the first layer forming at least a part of the surface of the product,
   and
forming the second layer of the product, the second layer comprising thermoplastic polymer and impurities,
   wherein the amount of the impurities is greater in the second layer of the composite product than in the first layer of the composite product.

Advantageously, the first layer and the second layer are formed in a lamination process, a gluing process, a molding process, an extrusion process, or a welding process.

Advantageously the first layer and the second layer are formed in a co-extrusion process. This process may be an effective way to manufacture the product comprising two layers with different raw materials. For example, the flow properties of raw materials may be separately controlled during the co-extrusion process.

In an example, the first layer and the second layer are first formed separately, for example in an injection molding process or in an extrusion process, after which the layers are attached to each other, for example, in a lamination process.

According to an advantageous embodiment of the invention, one of the dimensions of the composite product is at least 10 times greater than two other dimensions of the product.

Advantageously, the natural fiber plastic composite product is a building element, such as a decking board or a façade panel, or a landscaping element. In an example, the product is a railing, a fence, or a noise barrier. The natural fiber plastic composite product may also be a product that is used to cover the surface of another product, such as a cover strip.

Aspects of the invention are characterized by what is stated in the independent claims 1, 24, 26, 27, 28, and 29. Various embodiments of the invention are disclosed in the dependent claims.

### DESCRIPTION OF THE DRAWINGS

In the following, the invention will be illustrated by drawings in which

FIGS. 1a-1e show examples of a product, and

FIG. 2 shows an example of an arrangement according to the present invention, and

FIG. 3 shows an example embodiment of a method according to the present invention in reduced schematic chart.

### DETAILED DESCRIPTION OF THE INVENTION

In the following disclosure, all percentages are by dry weight, if not indicated otherwise.

The following reference numbers are used in this application:

11 natural fiber plastic composite product, also called composite product,

12 first layer of the natural fiber plastic composite product,

12a thickness of the first layer,

13 second layer of the natural fiber plastic composite product,

13a thickness of the second layer,

14 hole in the natural fiber plastic composite product,

21 fastener,

21b head of the fastener,

22 fastening member,

23 base element,

31 raw materials for the natural fiber plastic composite product, and

32 apparatus adapted to form the natural fiber plastic composite product.

In this application the term “first layer” 12 of the natural fiber plastic composite product 11 refers to a layer that forms at least a part of the surface area of the composite product 11. Advantageously, the first layer 12 is at least partly visible when the product 11 is in use. For example, in the case of a building element, the first layer 12 preferably forms the surface of a side that is visible in use. In the case of a decking board that forms a part of a floor, the first layer 12 advantageously covers at least the top side of said decking board.

The term “second layer” 13 of the natural fiber plastic composite product 11 refers to a layer that is at least partly covered by the first layer 12. In other words, the term “second layer” 13 of the natural fiber plastic composite product 11 refers to a layer that is at least partly “underneath” the first layer 12. Preferably, the second layer 13 is not visible when the product 11 is in use. However, in an example, the second layer is partly visible when the product 11 is in use.

The natural fiber plastic composite product 11 according to the present invention comprises two layers. It may also comprise more than two layers, for example, three, four, five, six, seven, eight, or even more than eight layers. Advantageously, the product 11 comprises two, three or four layers. In an example, there is at least one adhesive layer between the first layer and the second layer.

In this application, the term “cellulose based particles” refers to cellulose particles that can originate from any plant material that contains cellulose. The particles can be in the form of dust (powder); preferably they are, at least partly, in the form of fibers. In this application, the particles having a length of at least 0.1 mm, more preferably at least 0.2 mm are called fiber particles or fibers, and smaller particles than those mentioned above are called powder-particles or powder.

The natural fiber plastic composite may be, for example, a wood plastic composite, i.e. the cellulose based particles originate from wood. In an example, at least 30 wt. %, more preferably at least 80 wt. % and most preferably at least 90 wt. % of the cellulose based particles of the first and/or the second layer 13 are wood based particles. The wood material can be softwood trees, such as spruce, pine, fir, larch, douglas-fir or hemlock, or hardwood trees, such as birch, aspen, poplar, alder, eucalyptus, or acacia, or a mixture of softwoods and hardwoods. Non-wood material can be agricultural residues, grasses or other plant substances such as straw, leaves, bark, seeds, hulls, flowers, vegetables or fruits from cotton, corn, wheat, oat, rye, barley, rice, flax, hemp, manila hemp, sisal hemp, jute, ramie, kenaf, bagasse, bamboo, or reed. The cellulose based particles may be virgin or recycled.

Advantageously, the cellulose based particles in the first layer 12 of the product 11 comprise cellulose based particles that have a low lignin content. Advantageously, the cellulose based particles comprises chemically treated cellulose particles (i.e. so called lignin free cellulose particles). Alternatively or in addition, the cellulose based particles originate from plant material(s) in which the lignin content of the particles is naturally low.

The amount of the recycled raw materials as well as other raw materials of uneven quality and/or coloured raw materials may need to be increased in the composite product 11 due to environmental reasons and/or efficiency reasons. However, it has been observed that the amount of defects on the surface of the manufactured product 11 may increase with an addition of said raw materials and, therefore, the appearance and/or strength properties of the surface of the composite product 11 may decrease. Now, thanks to the novel composite product 11 comprising a first layer that covers at least a part of the surface of the product 11, it is possible to use a greater amount of recycled material and/or coloured material and/or material of uneven quality as raw material for the composite product 11 than in conventional products. Thus, the novel product 11 may be more environmentally friendly and/or more economical than conventional products.

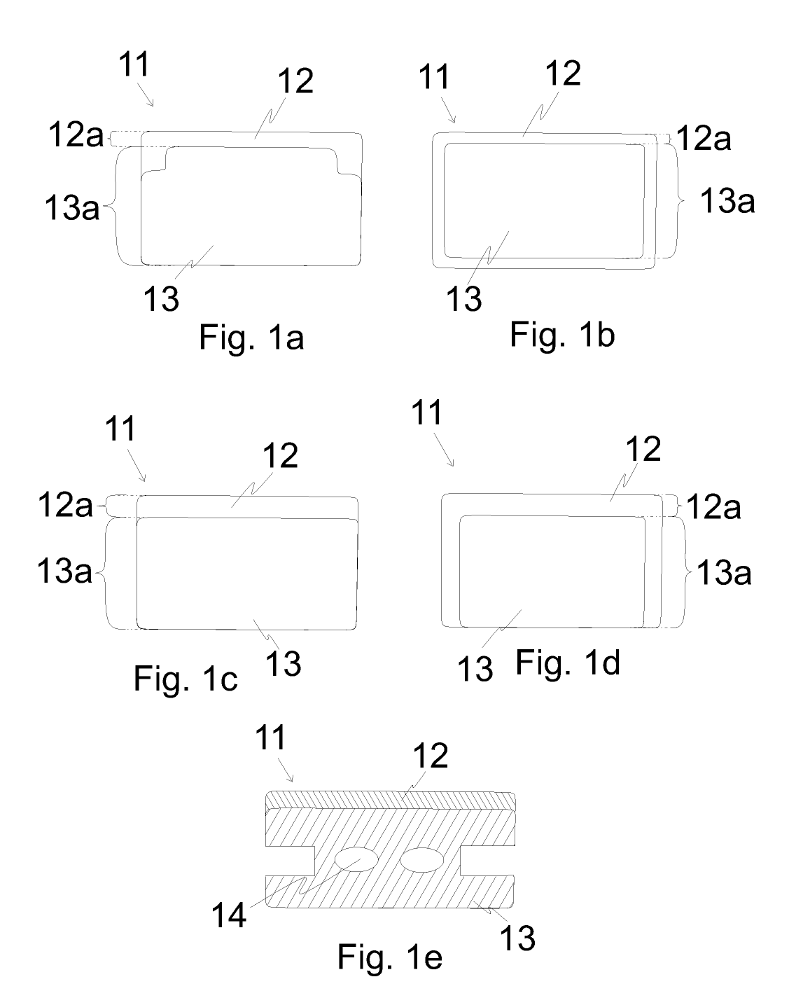

FIGS. 1a to 1e show some examples of the product 11 comprising the first layer 12 and the second layer 13. In FIGS. 1a to 1e, among other things, the thickness 12a of the first layer 12 and the thickness 13a of the second layer are illustrated. FIG. 1e shows an example of a composite product 11 having holes 14.

The first layer 12 may form the entire surface area of the product 11. In this case, the first layer 12 covers the second layer 14 totally. Alternatively, only a part of the second layer 13 may be covered by the first layer 12.

FIGS. 1a and 1c show examples in which the first layer 12 covers one surface of the composite product 11. FIG. 1b shows an example in which the first layer 12 covers at least four surfaces of the composite product 11 at least partly, preferably the whole surface area of the composite product 11. FIG. 1d shows an example in which the first layer 12 covers at least three of the surfaces at least partly. FIG. 1e shows an example of the end side of a building panel. The building panel shown in FIG. 1e comprises two holes 14, but the number of the holes may vary. Preferably, the composite product comprises one, two, three, four, five or six holes 14. In another example, the composite product does not comprise any holes 14. Thus, the product 11 may be formed as a solid or hollow profile. The weight of the composite product 11 typically decreases due to the holes 14.

Advantageously, the first layer 12 of the composite product forms at least 50% or at least 60%, more preferably at least 70% or at least 80%, and most preferably at least 90% or at least 95% of the surface area of the composite product 11. Most advantageously, the first layer 12 of the composite product forms at least 60% or at least 70%, more preferably at least 80% or at least 90% and most preferably at least 95% or at least 99% of the surface area of the product 11 that is visible in use.

The thickness 12a of the first layer 12 of the composite product 11 is preferably at least 0.2 mm or at least 0.3 mm, more preferably at least 0.4 mm or at least 0.5 mm, and most preferably at least 0.6 mm or at least 0.7 mm. In addition, the thickness 12a of the first layer 12 of the composite product 11 is preferably not greater than 5 or 4 mm, more preferably not greater than 3 or 2.5 mm, and most preferably not greater than 2.0 or 1.5 mm. In an example, the thickness 12a of the first layer 12 is between 0.2 and 5 mm. The thickness 12a of the first layer 12 of the composite product 11 is preferably determined as the median thickness of the first layer. If the product 11 comprises a side that is visible when the product 11 is in use, the thickness 12a of the first layer 12 is preferably determined as the median thickness of that side of the product 11.

The thickness 13a of the second layer is preferably between 0.5 and 40 mm, more preferably between 1 and 20 mm, and most preferably between 3 and 10 mm. The thickness 13a of the second layer 13 is preferably calculated as the median thickness of the second layer.

The natural fiber plastic composite product 11 is advantageously a building element, such as a decking board or a façade panel. In the case of the decking board or the façade panel, the product may comprise holes 14, or the product may be a so called solid profile without any holes 14.

Advantageously, the length of the product 11 is at least 10 times, more preferably 50 or 100 times, and most preferably 200 times greater than the thickness of the product 11. Alternatively or in addition, the width of the product 11 is at least 2 times, more preferably at least 3 times, and most preferably at least 5 times greater than the thickness of the product 11.

The first layer 12 of the composite product 11 comprises cellulose based particles. Due to the cellulose based particles, the properties of the first layer may be improved. Advantageously, the amount of the cellulose particles in the first layer 12 of the product 11 is between 5 and 80 wt. %, or between 10 and 70 wt. %, more preferably between 15 and 60 wt. % or between 20 and 50 wt. %, and most preferably between 30 and 40 wt. %. The cellulose particles preferably comprise wood dust and/or mechanical pulp and/or chemical pulp, from which the chemical pulp in powder form or fiber form is preferably used, and chemical pulp in the form of fibers is most preferably used. Advantageously, at least 60 w-%, preferably at least 70 w-% or at least 80 w-%, and most preferably at least 90 w-% or at least 95 w-% of the cellulose based particles in the first layer 12 of the product 11 are particles having a low lignin content, i.e. chemically treated cellulose particles and/or plant material in which the lignin content of the fibers is naturally low. Advantageously, the amount of the lignin in the first layer 12 of the product 11 calculated from the total amount of the cellulose based particles is lower than 15 wt. % or lower than 10 wt. %, more preferably lower than 5 wt. % or lower than 3 wt. %, and most preferably lower than 2 wt. % or lower than 1 wt. %.

Advantageously, the first layer 12 of the natural fiber plastic composite product 11 comprise thermoplastic polymer. Advantageously the total amount of the thermoplastic polymer(s) is from 20 to 80 wt. %, preferably from 20 to 60 wt. % of the first layer 12. The first layer 12 may comprise thermoplastic polymers that are virgin and/or recycled. Advantageously, the first layer 12 comprises virgin thermoplastic polymer(s). Preferably, the thermoplastic polymer comprises or consists of polyolefin, i.e. polypropylene (PP) and/or polyethylene (PE). If polyolefin is used, a low temperature may be used in the manufacturing process of the composite product 11; hence, darkening of the cellulose based particles may be avoided. Advantageously, at least 60 wt. % or at least 70 wt. %, more preferably at least 75 wt. % or at least 80 wt. % and most preferably at least 85 wt.% or at least 90 wt.% of the thermoplastic polymers used in the first layer 12 are polyolefins.

In an example, the thermoplastic polymer comprises polylactide (PLA). In this case, the total amount of the polylactides is advantageously at least 30 wt. % or at least 40 wt. %, more preferably at least 50 wt. % or at least 60 wt. % and most preferably at least 70 wt. % or at least 80 wt. % of the thermoplastic polymers in the first layer 12.

In an example, the first layer and/or the second layer of the product 11 comprises polyvinyl chloride (PVC). In this case, the total amount of the PVC:s in said layer is advantageously at least 10 wt. %, more preferably at least 30 wt. %, and most preferably at least 50 wt. % of plastic polymers in said first layer.

The first layer 12 may comprise mineral fillers. The mineral filler preferably comprises kaolin clay, wollastonite, ground calcium carbonate, precipitated calcium carbonate, titanium dioxide, talcum, or a mixture consisting two, three, four, five or six of said mineral fillers. Most preferably, the mineral filler in the first layer 12 comprises or consists of talcum.

Advantageously, the first layer 12 comprises from 20 to 80 wt. % thermoplastic polymers, from 5 to 80 wt. % cellulose based particles, and from 0 to 20 wt. % mineral fillers, the total content of said materials forming at least 90 wt. %, more preferably at least 95 wt. % and most preferably at least 97 wt. % of the first layer 12. In addition, the first layer 12 may comprise, for example, additives, such as colorants, UV stabilizers, coupling agents, foaming agents (blowing agents) and/or lubricants.

At least in the case of polyolefin, the composite product 11 preferably comprises coupling agent(s).

The coupling agent may comprise, for example,
maleic anhydride functionalized HDPE,
maleic anhydride functionalize LDPE,
maleic anhydride functionalized EP copolymers,
acrylic acid functionalized PP, HDPE, LDPE, LLDPE, and EP copolymers,
styrene/maleic anhydride copolymers,
vinyl trialkoxy silanes, or
combinations thereof.

The second layer 13 that is at least partly covered by the first layer 12 may comprise, for example, recycled material(s) comprising different colours. Due to the first layer 12, the composite product 11 may be weatherproof, it may have good strength properties, and there may not be any defects on the surface of the product 11; even the raw materials of the second layer 13 may vary from time to time.

The second layer 13 of the composite product 11 preferably comprises cellulose based particles. The cellulose particles of the second layer preferably comprise wood dust, and/or mechanical pulp, and/or chemical pulp (powder and/or fibers) and/or recycled paper and/or recycled label material, from which the wood dust, mechanical pulp, recycled paper and/or recycled label material are preferably used. The amount of the cellulose based particles in the second layer is preferably between 20 and 80 wt. %, from which preferably at least 60 wt. %, more preferably at least 70 wt. % and most preferably at least 80 wt. % comes from recycled paper and/or recycled label material and/or wood dust and/or mechanical pulp.

In an example, the recycled label material used in the second layer 13 of the composite product 12 comprises:
coated and/or uncoated papers, comprising cellulose based particles and possible pigments, the total amount of the papers being, for example, at least 20 wt. %, and/or
water-based acrylic polymer adhesives, hotmelt adhesives, and/or rubber adhesives, the total amount of the adhesives being, for example, 20 wt. % at the most, and/or
silicone release agents, the total amount being, for example, 5 wt. % at the most, and/or
Plastic film(s), for example, polyethylene (PE), polypropylene (PP), polystyrene (PS) and/or polyethylene terephthalate (PET), the total amount of the plastic films being, for example, 80 wt. % at the most, and/or
talcum, the total amount being, for example, 20 wt. % at the most, the total amount of the above mentioned materials in the recycled label material being 100 wt. % at the most.

Advantageously, the second layer 13 of the natural fiber plastic composite product 11 comprises from 20 to 80 wt. % (dry weight) plastic polymers, preferably thermoplastic polymers. Advantageously, the total amount of the thermoplastic polymers is from 20 to 60 % of dry weight. Advantageously, the total amount of the polyolefin is at least 60 wt. % or at least 70 wt. %, more preferably at least 75 wt. % or at least 80 wt. %, and most preferably at least 85 wt. % or at least 90 wt. % of the thermoplastic polymers used in the second layer 13.

The second layer 13 may comprise plastic polymers that are virgin and/or recycled. Preferably at least 50 wt. %, more preferably at least 60 wt. % of the plastic polymers in the second layer 13 are recycled. It is also possible to use only recycled plastic polymers in the second layer 13. Advantageously, the second layer 13 comprises at least one kind of recycled plastic polymer, more preferably the second layer 13 comprises at least two kinds of recycled plastic polymers. In an example, the recycled plastic polymer comprises PE and/or PP and/or PVC.

The second layer 13 may comprise a mineral filler. The mineral filler preferably comprises kaolin clay, ground calcium carbonate, precipitated calcium carbonate, titanium dioxide, wollastonite, talcum, or a mixture of these. In an example, at least 30 wt. % or at least 50 wt. % of the mineral fillers of the second layers 13 originates from recycled raw materials, such as recycled uncoated and/or coated paper, paperboard and/or board material.

However, advantageously at least 60 wt. %, more preferably at least 80 wt. % of the mineral fillers are supplied to the system as separated raw material(s), i.e. not as a part of recycled paper, paperboard or board material.

In addition to those mentioned above, the second layer 13 may comprise, for example, additives, such as colorants, UV stabilizers, coupling agents, foaming agents (blowing agents) and lubricants.

The second layer 13 preferably comprises so called impurities originating, for example, from the recycled material(s). Advantageously, the amount of the impurities is greater in the second layer 13 of the product 11 than in the first layer 12 of the product 11.

The impurities may comprise or consist of lignin, print ink, silicone, and adhesives. Advantageously, the impurities comprise lignin. Mechanically treated cellulose based particles typically comprise lignin impurities. Lignin may bind particles together in the second layer. However, it is not wanted in the surface of the product because it may cause problems on the surface of the composite product 11, such as yellowing of the surface.

The second layer preferably comprises cellulose based particles that are mechanically treated. The mechanically treated cellulose based particles may be, for example, ground, refined and/or powdered from the cellulose source used. In other words, the cellulose source of the cellulose based particles is advantageously mechanically treated but not chemically treated. Some examples of mechanically treated cellulose based particles are wood dust, mechanical pulp, and recycled paper, which typically comprises lignin. Chemical pulp is so called lignin free material, which is chemically treated. In addition, recycled label material typically comprises chemically treated cellulose based particles.

Advantageously, the impurities of the natural fiber plastic composite product comprise lignin. Preferably, the lignin, at least in the second layer 13, is at least predominantly in the cellulose based particles, the “predominantly” meaning at least 50 wt. %, more preferably at least 70 %, and most preferably at least 90 wt. %. Most advantageously, the cellulose based particles in the second layer (13) that comprise the lignin are in a form of wood dust and/or mechanical pulp.

The appearance of the composite product 11 may be good due to the first layer 12 in spite of the impurities, such as lignin, in the second layer 13 of the composite product 11. Advantageously, the total amount of the impurities, preferably the total amount of lignin, print ink, silicone and adhesives, is at least 30 wt. % or at least 45 wt. %, more preferably at least 60 wt. % or at least 75 wt. %, and most preferably at least 85 wt. % or at least 90 wt. % greater in the second layer 13 of the product 11 than in the first layer 12 of the product 11.

Advantageously, the total amount of the lignin(s), print ink(s), silicone(s) and adhesive(s) in the second layer 12 of the composite product 11 is at least 1.3 or 1.7 or 2 times the total amount of the lignin(s), print ink(s), silicone(s) and adhesive(s) in the first layer 13 of the composite product 11, more advantageously at least 5, 10 or 20 times the total amount of the lignin(s), print ink(s), silicone(s) and adhesive(s) in the first layer 13 of the composite product 11 and most advantageously at least 50, 80 or 100 times the total amount of the lignin(s), print ink(s), silicone(s) and adhesive(s) in the first layer 13 of the composite product 11.

The first layer 12 preferably comprises less than 5 wt. % or less than 3 wt. %, more preferably less than 2 wt. % or less than 1 wt. % and most preferably less than 0.5 wt. % of impurities. Most preferably, the first layer 12 comprises less than 5 wt. % or less than 3 wt. %, more preferably less than 2 wt. % or less than 1 wt. % and most preferably less than 0.5 wt. % of materials that consist of lignin, print ink, silicone and adhesives. Most advantageously, the first layer 12 comprises less than 5 wt. % or less than 3 wt. %, more preferably less than 2 wt. % or less than 1 wt. % and most preferably less than 0.5 wt. % of lignin.

The second layer 13 preferably comprises at least 1 wt. % said impurities, more preferably at least 2 wt. % said impurities and most preferably at least 3 wt. % of said impurities. Advantageously, the second layer 13 comprises at least 1 wt. %, more preferably at least 2 wt. % and most preferably at least 3 wt. % lignin.

Thanks to the small amount of the impurities in the first layer 12, and the thermoplastic polymer and the cellulose particles therein, the surface of the product 11 may have good strength properties together with a good appearance even if the product 11 comprises a significant amount of impurities in the second layer 13 of the product 11.

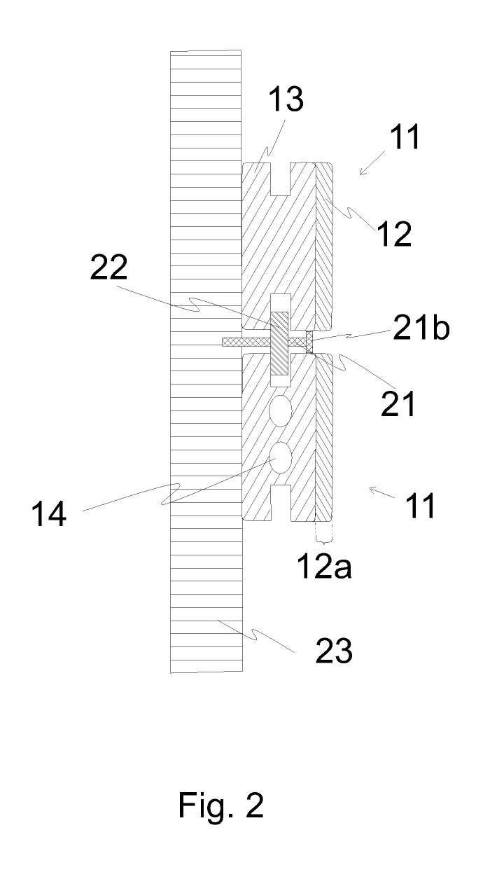

FIG. 2 shows an example of an arrangement according to the present invention. In FIG. 2 the composite product 11, the first layer 12, a thickness 12a of the first layer, the second layer 13, a hole 14 of the product 11, a fastener 21, a head 21b of the fastener, a fastening member 22, and a base element 23 are shown.

Preferably, the composite product 11 has a structure that is compatible with the fastening member 22 in order to achieve good fastening of the composite product 11 to the base element 23. There may be some thermal expansion in the composite product 11 in use that needs to be taken into account.

According to an advantageous embodiment of the invention, the composite product is a decking board or a façade panel and the structure of the composite product 11 is such that a fastening member 22, preferably a so called T-clip manufactured by UPM Corporation, can be used with the composite product 11. The fastening member 22 may be used in order to fasten the manufactured composite product, preferably together with a fastener 21, such as a screw or a nail. The fastener 21 may also be used without the fastening member 22. In an example, the composite product comprises elongated holes that are used for the fasteners 21, for example a screw or a nail. Thanks to the elongated holes, thermal expansion of the composite product is allowed. In another example, the fastening of implemented by so called support rail fastening member, such as an alu rail fastening member.

Advantageously, the product 11 is installed in such a way that the first layer 12 forms the surface of the product 11 that is visible. Advantageously, the natural fiber plastic composite product 11 is fastened in order to form a part of the building. In an example, the natural fiber plastic composite is fastened in order to form a part of the terrace.

In an advantageous example, the fastener 21 comprises a head 21b. In this case, the fastener may be, for example, a screw or a nail, preferably the screw. Advantageously the head 21b of the screw 21 is parallel with the surface of the product 11 as is shown in FIG. 2. Advantageously, the fastener 21 is used together with a fastening member 22 to fasten the composite product 11 to the base element 23. The fastening member may have, for example, a T-profile.

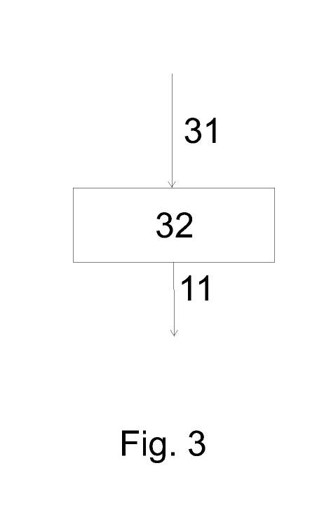

FIG. 3 shows an example embodiment of the present invention in a reduced schematic chart. FIG. 3 shows raw material 31 for the natural fiber plastic composite product 11, an apparatus 32 adapted to form the natural fiber plastic composite product 11, and a natural fiber plastic composite product 11.

The system according to the present invention preferably comprises at least one supplying device to feed the raw materials 31 to the apparatus 32, which apparatus 32 forms the natural fiber plastic composite product 11.

The first layer 12 and the second layer 13 are preferably formed by an extrusion process using an extruder. Advantageously, the first layer 12 and the second layer 13 are formed by a co-extrusion process using an extruder. In these cases, the apparatus 32 comprises the extruder.

In an example, the product 11 is manufactured in a moulding process, such as an injection moulding process, or in a lamination process, a gluing process, a molding process, or a welding process.

In an example, the layers are first formed separately, for example in a molding process or in an extrusion process, after which the formed layers are attached to each other, for example, in a lamination process. In other words, the first layer 12 and the second layer 13 may be laminated with each other in order to form the product 11. In this case, the apparatus 32 comprises a laminating device.

A person skilled in the art readily understands different embodiments of the invention. Therefore, it is obvious that the present invention is not limited solely to the above-presented embodiments, but it can be modified within the scope of the appended claims.

1-27. (canceled)

28. A natural fiber plastic composite product comprising a first layer and a second layer, the first layer forming at least a part of the surface of the product, wherein
the first layer comprises thermoplastic polymer and cellulose based particles in the form of fibers having a length of at least 0.1 mm, and
the second layer comprises thermoplastic polymer and impurities comprising lignin,
wherein the amount of the impurities is at least 30 wt. % greater in the second layer of the product than in the first layer of the product, wherein the content of the lignin in the first layer calculated from the total amount of cellulose fibers is less than 15 wt. % wherein the product is obtained by using a co-extrusion process to form the first layer and the second layer of the product.

29. The natural fiber plastic composite product according to claim 28, wherein the second layer comprises cellulose based particles.

30. The natural fiber plastic composite product according to claim 28, wherein the first layer comprises less than 5 wt. % of impurities.

31. The natural fiber plastic composite product according to claim 28, wherein the impurities consist of lignin(s), print ink(s), silicone(s) and adhesive(s).

32. The natural fiber plastic composite product according to claim 31, wherein the lignin is at least mostly in the cellulose based particles.

33. The natural fiber plastic composite product according to claim 32, wherein the cellulose based particles in the second layer comprise wood dust and/or mechanical pulp.

34. The natural fiber plastic composite product according to claim 28, wherein the content of lignin in the first layer is lower than 3 wt. %.

35. The natural fiber plastic composite product according to claim 28, wherein the first layer comprises from 20 to 80 wt. % of thermoplastic polymers, from 5 to 80 wt. % of cellulose based particles, and from 0 to 20 wt. % of mineral fillers, the total content of said materials being at least 90 wt. % of the first layer.

36. The natural fiber plastic composite product according to claim 28, wherein the first layer comprises talcum.

37. The natural fiber plastic composite product according to claim 28, wherein at least 90 wt. % of the cellulose based particles in the first layer are chemically treated particles.

38. The natural fiber plastic composite product according to claim 28, wherein at least 30 wt. % of the cellulose based particles in the first layer are wood particles.

39. The natural fiber plastic composite product according to claim 28, wherein the thickness of the first layer is between 0.3 and 5 mm.

40. The natural fiber plastic composite product according to claim 28, wherein the thickness of the second layer is between 0.5 and 40 mm.

41. The natural fiber plastic composite product according to claim 28, wherein the content of impurities in the second layer is at least 1 wt. %.

42. The natural fiber plastic composite product according to claim 28, wherein the thermoplastic polymer comprises polyolefin.

43. The natural fiber plastic composite product according to claim 28, wherein the length of the product is at least 10 times greater than the thickness of the product.

44. The natural fiber plastic composite product according to claim 28, wherein the product is a building element, such as a decking board or a façade panel.

45. The natural fiber plastic composite product according to claim 28, wherein the product is a railing or a fence.

46. The natural fiber plastic composite product according to claim 28, wherein the product is a cover strip.

47. The natural fiber plastic composite product according to claim 28, wherein the product is a noise barrier.

48. The natural fiber plastic composite product according to claim 28, wherein the content of lignin in the first layer is lower than 1 wt. % and the content of lignin in the second layer is at least 3 wt. %.

49. A method for manufacturing a natural fiber plastic composite product comprising a first layer and a second layer, the first layer forming at least a part of the surface of the product, wherein the method comprises:
forming the first layer of the product, the first layer comprising thermoplastic polymer material and cellulose fibers having a length of at least 0.1 mm, and
forming the second layer of the product, the second layer comprising thermoplastic polymer material and impurities comprising lignin,
using a co-extrusion process to form the first layer and the second layer of the product,
wherein the content of the impurities is at least 30 wt. % greater in the second layer than in the first layer of the product, and the content of the lignin in the first layer calculated from the total amount of cellulose fibers is less than 15 wt. %.

50. The method of claim 49, wherein the content of lignin in the first layer is lower than 1 wt. % and the content of lignin in the second layer is at least 3 wt. %.

51. A building comprising a natural fiber plastic composite product according to claim 28, and a fastener, wherein the natural fiber plastic composite is fastened by the fastener in order to form a part of the building.

52. A terrace comprising a natural fiber plastic composite product according to claim 28, and a fastener, wherein the natural fiber plastic composite is fastened by the fastener in order to form a part of the terrace.

53. An arrangement comprising a natural fiber plastic composite product according to claim 28, a fastener, a fastening member, and a base element, wherein the natural fiber plastic composite product is fastened to the base element by the fastening member and the fastener, wherein the fastener comprises a head, and the head is parallel with a surface of the product.
